(19) United States
(12) Patent Application Publication
(10) Pub. No.: US 2019/0094585 A1
(43) Pub. Date: Mar. 28, 2019

(54) LIQUID CRYSTAL CELL AND METHOD OF PRODUCING LIQUID CRYSTAL CELL

(71) Applicant: SHARP KABUSHIKI KAISHA, Osaka (JP)

(72) Inventors: Katsuya OGAWA, Sakai City (JP); Tomonari IKEDA, Sakai City (JP)

(21) Appl. No.: 16/136,253

(22) Filed: Sep. 20, 2018

(30) Foreign Application Priority Data
Sep. 25, 2017 (JP) 2017-183874

(51) Int. Cl. G02F 1/1339; G02F 1/1335; G02F 1/1341

(52) U.S. Cl. CPC G02F 1/1339; G02F 1/1341; G02F 1/13394; G02F 1/133512

(57) ABSTRACT

A liquid crystal cell includes a first substrate with a plate surface including a display area, a second substrate opposed to the first substrate, a sealant bonding the first substrate and the second substrate together with a cell gap, a liquid crystal layer, a base layer, and a protrusion. The sealant includes a surrounding wail and passage walls. The surrounding wall defines the filling space overlapping the display area and an entrance to the filling space. The passage walls define a passage to the entrance to the filling space to pass a liquid crystal material. The liquid crystal layer is disposed in the filling space. The base layer is disposed on a section of a plate surface of one of the first substrate and the second substrate in the passage. The protrusion protrudes from the base layer toward another one of the first substrate and the second substrate.

### CROSS REFERENCE TO RELATED APPLICATION

This application claims priority from Japanese Patent Application No. 2017-183874 filed on Sep. 25, 2017. The entire contents of the priority application are incorporated herein by reference.

### TECHNICAL FIELD

The technology described herein relates to a liquid crystal cell and a method of producing a liquid crystal cell.

### BACKGROUND

A vacuum injection method has been known as a method of producing a liquid crystal cell. The vacuum injection method includes preparing a pair of substrates including various layers formed on plate surfaces opposed to each other, disposing a sealer on an edge area of one of the substrates with an inlet through which a liquid crystal material is injected, bonding the substrate together while holding the substrate with a gap therebetween (a cell gap), injecting the liquid crystal material into a filling space between the substrate through the inlet, and sealing the inlet. Through those steps, the liquid crystal cell is produced. If foreign substances are mixed into the liquid crystal material and enclosed in a liquid crystal layer in the gap, display defects or short-circuits between electrodes may be produced in a display area in which images are displayed. Namely, image display quality or display reliability may be reduced. A technology to solve such a problem is proposed in Japanese Unexamined Patent Application Publication No. 2008-241752. According to the technology, ribs are provided at the inlet to close a part of the inlet in the height direction to block the foreign substances from entering the gap.

The ribs include a first rib and a second rib. The first rib in the inlet is located closer to an outer edge of the substrate and made of resin the same as that of color layers of color filters. If the first rib and the color layers in the display area are formed at the same time, the height of the first rib is about equal to the thickness of the color layer. Therefore, a gap about equal to the cell gap (or the thickness of the liquid crystal layer) in the display area is formed between the first rib and the opposed substrate. Performance of the first rib to block foreign substances may not be high because relatively large foreign substances can pass according to the configuration of the first rib.

The second rib in the inlet closer to the liquid crystal layer is formed through patterning together with spacers that are provided to hold the cell gap. The spacers and the second rib are formed using a known photolithography. The spacers are formed in the display area in which the color layers having a relatively large thickness are formed and the second rib is formed in a non-display area in which a common electrode having a smaller thickness is formed. To form the second rib having a sufficient height, an intensity of light or exposure time needs to be increased in comparison to a normal exposure process in formation of spacers. This may increase energy consumption or production time.

### SUMMARY

The technology described herein was made in view of the above circumstances. An object is to effectively reduce entrance of foreign substances into a liquid crystal layer of a liquid crystal cell produced by the vacuum injection method without increases in energy consumption and production time.

A liquid crystal cell includes a first substrate, a second substrate, a sealant, a liquid crystal layer, a base layer, and a protrusion. The first substrate includes a plate surface that includes a display area in which an image is displayed and a non-display area surrounding the display area. The second substrate is opposed to the first substrate. The sealant bonds the first substrate and the second substrate together with a cell gap between the first substrate and the second substrate. The sealant is disposed along an outline of the filling space to include a surrounding wall and passage walls. The surrounding wall defines the filling space overlapping the display area and an entrance to the filling space. The passage walls define a passage from an outer edge of the first substrate to the entrance to the filling space to pass a liquid crystal material therethrough. The liquid crystal layer including the liquid crystal material is disposed in the filling space and has a thickness corresponding to the cell gap. The base layer is made of organic material and has a thickness of 1 μm or greater on a section of a plate surface of at least one of the first substrate and the second substrate in the passage. The protrusion protrudes from the base layer toward another one of the first substrate and the second substrate.

According to the configuration described above, the base of the protrusion is raised by the base layer that has a relatively large thickness among layers on the first and the second substrates. Namely, in the passage through which the liquid crystal material is passed to fill the filling space with the liquid crystal material, the top of the protrusion is located higher in comparison to a configuration in which the base is not raised by the base layer. During the injection of the liquid crystal material, the entrance of foreign substances is efficiently reduced with the protrusion having the relatively small height. The entrance of foreign substances is reduced regardless of thickness of the layers on the substrates. Without largely altering steps of known production method or conditions, the entrance of foreign substances into the liquid crystal layer is efficiently reduced and the liquid crystal cell having higher display quality and reliability can be achieved.

The spacer for maintaining the cell gap is provided in the display area. The protrusion may be made of the same material as that of the spacer and disposed in the layer in which the spacer is disposed. According to the configuration, the protrusion having a height about equal to the height of the space is formed on the base layer simultaneously with the spacer without increasing an exposure time in lithography processing.

A liquid crystal cell that includes a first substrate including a plate surface including a display area and non-display area surrounding the display area and a second substrate opposed to the first substrate is produced by a method including: forming a functional layer on any one of the first substrate and the second substrate from an organic material and with a thickness of 1 μm or greater; defining a section of the functional layer in an area of the any one of the first substrate and the second substrate to form a passage for a liquid crystal material as a base layer; forming a spacer to protrude from the functional layer with a height corresponding to a cell gap between the first substrate and the second substrate; forming a protrusion simultaneously with the forming of the spacer to protrude from the base layer toward another one of the first substrate and the second substrate; applying a sealant to a peripheral section of the plate surface of the first substrate except for an area corresponding to the passage and sections of the plate surface of the first substrate adjacent to sides of the area corresponding to the passage; defining a section of the sealant applied to the peripheral section as a surrounding wall; defining sections of the sealant applied to the sides of the area corresponding to the passage as passage walls; holding the first substrate to the second substrate with the sealant with the cell gap between the first substrate and the second substrate; defining a space defined by the surrounding wall between the first substrate and the second substrate as a filling space; and injecting the liquid crystal material into the filling space via the passage defined by the passage walls.

According to the method, the liquid crystal cell according the technology described herein can be produced without increasing the number of steps in comparison to the known method.

According to the technology described herein, a liquid crystal cell having high display quality and display reliability is produced.

### BRIEF DESCRIPTION OF THE DRAWINGS

FIG. 1 is a cross-sectional schematic view illustrating a two-dimensional configuration of a liquid crystal cell according to a first embodiment before a liquid crystal material is injected.

FIG. 2 is a schematic view illustrating a YZ cross section of the liquid crystal cell along line A-A in FIG. 1 during injection of the liquid crystal material.

FIG. 3 is a schematic view illustrating an XY cross section of the liquid crystal cell along line B-B in FIG. 2 before the liquid crystal material is injected.

FIG. 4 is a schematic view illustrating a YX cross section of a liquid crystal cell according to a second embodiment during injection of a liquid crystal material.

FIG. 5 is a schematic view illustrating a YZ cross section of the liquid crystal cell along line C-C in FIG. 4 before the liquid crystal material is injected.

### DETAILED DESCRIPTION

### First Embodiment

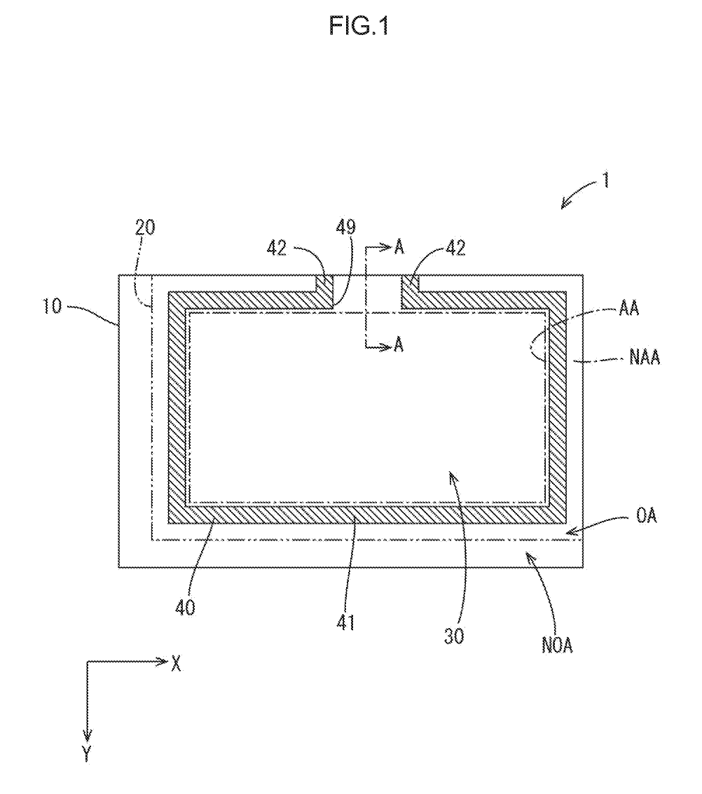

A first embodiment will be described with reference to FIGS. 1 to 3. In this section, a liquid crystal cell 1 will be described. X-axes, Y-axes, and Z-axes may be present in the drawings. The axes in each drawing correspond to the respective axes in other drawings. The upper side and the lower side in FIG. 1 correspond to an upper side and a lower side of the liquid crystal cell 1, respectively. The right side and the left side in FIG. 1 correspond to a right side and a left side of the liquid crystal cell 1, respectively. FIG. 1 illustrates a view of the liquid crystal cell 1 from the front side. Among the same components, only one of them may be indicated by a reference sigh and others may not be indicated by the reference sign.

The liquid crystal cell 1 has a screen size of about five inches. The screen size of the liquid crystal cell 1 can be altered where appropriate. The liquid crystal cell 1 can be used in various types of liquid crystal display devices.

As illustrated in FIG. 1, the liquid crystal cell 1 has a horizontally-long rectangular plate shape with long edges along the X-axis direction. A plate surface of the liquid crystal cell 1 includes a display area (an active area) AA and a non-display area (a non-active area) NAA. The display area AA is an inner area in which images are displayed. The non-display area NAA is an outer area in which images are not displayed. The non-display area NAA has a rectangular frame shape to surround the display area AA in a plan view. The short direction and the thickness direction of the liquid crystal cell 1 correspond with the Y-axis direction and the Z-axis direction in the drawings, respectively. In FIG. 1, a chain line indicates an outline of the display area AA and an area outside the chain line is the non-display area NAA.

The liquid crystal cell 1 includes a pair of substrates 10 and 20. One of the substrates 30 and 20 on the back side is an array substrate 10 (a second substrate, a TFT substrate, an active matrix substrate). As indicated by a two-dashed chain line in FIG. 1, a CF substrate 20 (a first substrate, a color filter substrate, a common substrate) is disposed over the front surface of the array substrate 10. The CF substrate 20 has a horizontal dimension (in the X-axis direction) and a vertical dimension (in the Y-axis direction) less than those of the array substrate 10, respectively. The array substrate 10 and the CF substrate 20 are opposed to each other with the upper edges and the right edges aligned. The CF substrate 20 does not overlap an area of the array substrate 10 closer to the left edge and the bottom edge of the array substrate 10. The area is defined as a substrate non-overlapping area NOA. An area of the array substrate 10 other than the substrate non-overlapping area NOA is defined as a substrate overlapping area OA. An entire plate surface of the CF substrate 20 is defined as a substrate overlapping area OA. The display area AA is located within the substrate overlapping area OA. The non-display area NAA includes an outer edge section of the substrate overlapping area OA and the entire substrate non-overlapping area NOA. In the substrate non-overlapping area NOA, terminals are disposed to which a transmission substrate connected to an external signal source and a power supply is connected.

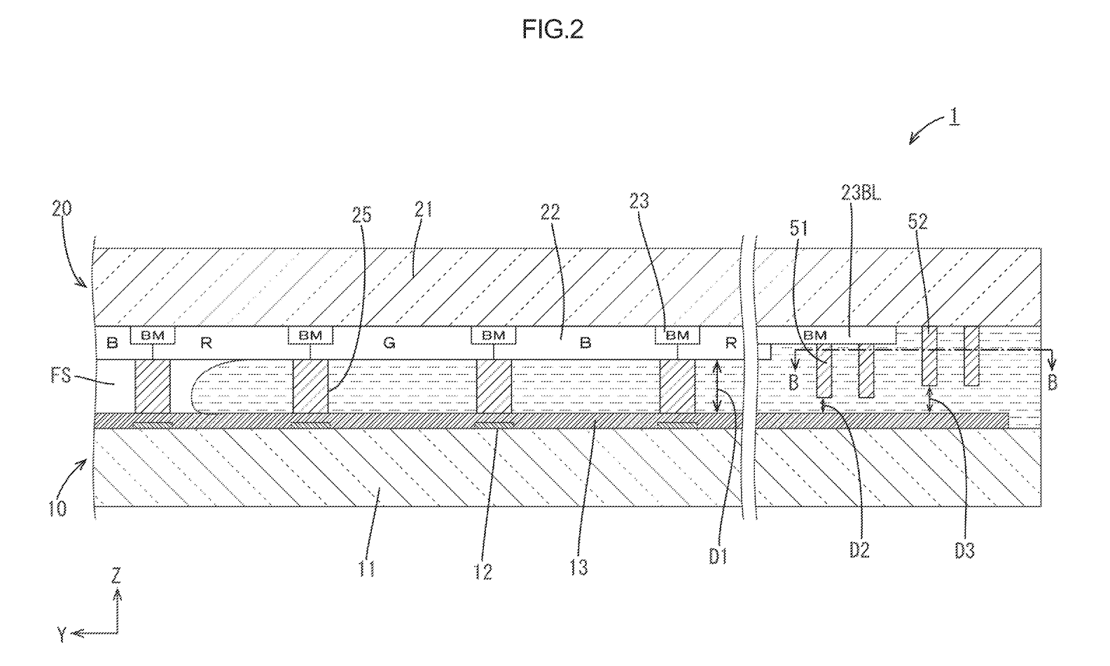

As illustrated in FIG. 2, the liquid crystal cell 1 further includes a liquid crystal layer 30 between the array substrate 10 and the CF substrate 20 and a sealant 40 (see FIG. 1). The sealant 40 is disposed between the array substrate 10 and the CF substrate 20 to enclose the liquid crystal layer 30 in the gal and to seal the gap. Polarizer plates may be attached to outer surfaces of the array substrate 10 and the CF substrate 20.

The array substrate 10 and the CF substrate 20 include glass substrates 11 and 21, respectively. Various kinds of layers are formed on opposed surfaces of the glass substrates 11 and 21.

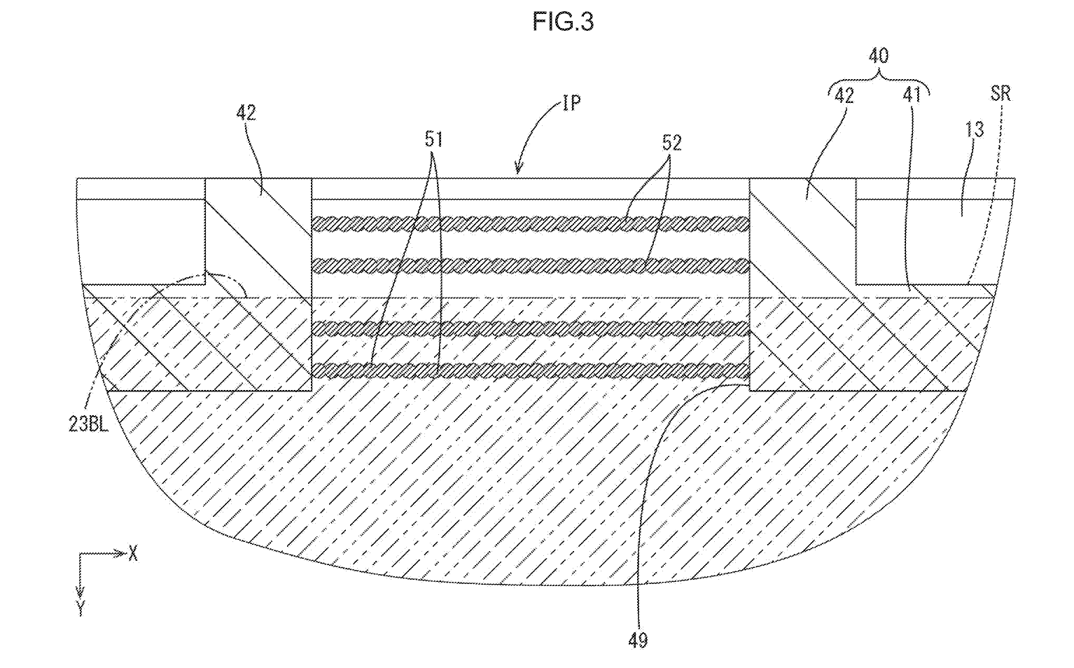

A configuration of the CF substrate 20 will be described. On the opposed surface of the glass substrate 21 (on a liquid crystal layer 30 side, an opposed side opposing the array substrate 10), a color filter is disposed in the display area AA. The color filter includes a color layer 22 and a black matrix (BM) layer 23 (a light blocking layer). As illustrated in FIG. 2, the color layer 22 includes color segments arranged in a matrix. The color segments include red (R) color segments, green (G) color segments, and blue (B) color segments that are repeatedly arranged in predefined sequence. The BM layer 23 is formed in a grid pattern including sections disposed between the color segments to reduce color mixture. The color layer 22 and the BM layer 23 are made of organic resin materials containing different color pigments. The thicknesses of the color layer 22 and the BM layer 23 are greater than the thicknesses of other layers made of inorganic materials. Specifically, the thickness of the color layer 22 is equal to or greater than 1 μm, for instance, about 2 μm. The thickness of the BM layer 23 is equal to or greater than 1 μm, for instance, about 1.5 μm. As illustrated in FIG. 3, the BM layer 23 extends over a boundary between the non-display area NAA and the display area AA. According to the configuration, leak of light from a peripheral of the screen is reduced and thus contrast improves. As illustrated in FIGS. 2 and 3, a section of the BM layer 23 in the non-display area NAA is defined as a base layer 23BL from which first ribs 51 protrude. The first ribs 51 will be described later.

An overcoat layer is formed on surfaces of the color layer 22 and the BM layer 23. Photo spacers 25 protrude from a surface of the overcoat layer. The photo spacers 25 are made of photo sensitive resin. Each of the photo spacers 25 has a columnar shape that protrudes from the surface of the CF substrate 20 toward the array substrate 10 in a predefined length. A distal end of each photo spacer 25 contacts an inner surface of the array substrate 10. With the photo spacers 25, the gap D1 (the cell gap) between the CF substrate 20 and the array substrate 10 is maintained.

An alignment film is formed on the innermost layer on the CF substrate 20 (on a liquid crystal layer 30 side) in the display area AA for controlling orientation of liquid crystal molecules in the liquid crystal layer 30. The alignment film is disposed over surfaces of the photo spacers 25. The alignment film contacts the liquid crystal layer 30. The liquid crystal layer 30 is held between the alignment film on the CF substrate 20 and an alignment film on the array substrate 10. The alignment films have functions for controlling orientation of the liquid crystal molecules held between the CF substrate 20 and the array substrate 10 in predefined directions. The alignment films may be made of polyimide. Polyimide films are formed into photo-alignment films by applying a light ray in a specific wavelength range (e.g., ultraviolet ray). The photo-alignment films are configured to orientate the liquid crystal molecules in a direction in which the light ray applied.

The configuration of the array substrate 10 will be described. On the opposed surface of the glass substrate 11 (on a liquid crystal layer 30 side, an opposed side opposing the CF substrate 20) in the display area AA, thin film transistors (TFTs) 12 and pixel electrodes are arranged in a matrix. The TFTs 12 are switching components. Furthermore, gate lines (scanning lines) and source lines (date lines, signal lines) are routed to surround the TFTs 12 and the pixel electrodes. The gate lines and the source lines are connected to gate electrodes and source electrodes of the TFTs 12, respectively. The pixel electrodes are connected to drain electrodes of the TFTs 12. The TFTs 12 are driven according to signals supplied through the gate lines and the source lines. Application of voltages to the pixel electrodes is controlled based on the driving of the TFTs 12. A common electrode is disposed to overlap the pixel electrodes. When potential differences are produced between the electrodes, fringe electric fields (oblique electric fields) are applied.

On the array substrate 10, a first metal layer (a gate metal layer), a gate insulating layer, a semiconductor layer, a second metal layer (a source metal layer), a first interlayer insulating layer, a planarization layer 13 (an insulating layer, a first insulating layer, a lower insulating layer), a first transparent electrode layer, a second interlayer insulating layer (an insulating layer, a second insulating layer, an upper insulating layer), a second transparent electrode layer, and the alignment film are formed in layers in this sequence from the lower side (on a glass substrate 11 side, a side farther from the liquid crystal layer 30). In FIG. 2, the planarization layer 13 having a relatively large thickness among the above-mentioned layers is illustrated.

The planarization layer 13 is made of photo-curable organic resin or thermosetting resin such as epoxy-based resin and phenol-based resin. The planarization layer 13 has a thickness greater than thicknesses of other layers made of inorganic resins. The thickness of the planarization layer 13 is equal to or greater than 1 μm, for instance, about 2 μm. With the planarization layer 13, the surface of the array substrate 10 is planarized. The thickness of the insulating layers made of inorganic material such as the second interlayer insulating layer is about 0.2 μm. The first interlayer insulating layer, the planarization layer 13, and the second interlayer insulating layer include contact holes for connecting the pixel electrodes constructed from the second transparent electrode film to the drain electrodes constructed from the second metal film. The planarization layer 13, the first interlayer insulating layer, and the second interlayer insulating layer are formed in solid patterns to cover at least the entire display area AA except for the contact holes. As illustrated in FIGS. 2 and 3, the planarization layer 13 extends from the display area AA to sections of the substrate overlapping area OA of the non-display area NAA closer to the outer edges. The alignment film is disposed over the surfaces of the second transparent electrode film and the second interlayer insulating film to contact the liquid crystal layer 30.

The liquid crystal layer 30 includes the liquid crystal molecules having optical characteristics that varies according to application of an electric field. As illustrated in FIG. 1, the liquid crystal layer 30 is disposed to cover the entire display area AA and sections of the non-display area NAA closer to the inner edges of the non-display area NAA. The liquid crystal layer 30 is prepared by injecting the liquid crystal material that is flowable into the filling space FS defined by the sealant 40 between the array substrate 10 and the CF substrate 20 and filling the filling space FS with the liquid crystal material.

The sealant 40 is made of photo-curable or thermosetting resin such as epoxy-based resin and phenol-based resin. The sealant 40 is disposed between the array substrate 10 and the CF substrate 20 with the predefined cell gap d1 therebetween. The sealant 40 defines the filling space FS that is filled with a liquid crystal material and an entrance 49 to the filling space FS through which the liquid crystal material is injected. The sealant 40 bonds the array substrate 10 and the CF substrate 20 together and seals the filling space FS in which the liquid crystal layer 30 is formed by filling the filling space FS with the liquid crystal material.

As illustrated in FIG. 1, the sealant 40 is disposed in a sealant placement area SR that includes a rectangular frame-shaped section and a pair of rectangular sections. The rectangular frame shaped section has a horizontally-long rectangular frame shape along edges of the display area AA in a plan view (in a direction normal to the plate surfaces of the array substrate 10 and the CF substrate 20) with a break in the middle of the upper edge of the display area AA. The rectangular sections extend from ends of the rectangular frame shaped section at the break to the upper edges of the array substrate 10 and the CF substrate 20. The sealant 40 is disposed in the rectangular frame shaped section and the rectangular section.

The sealant 40 includes a surrounding wall 41 disposed in the rectangular frame shaped section and passage walls 42 disposed in the rectangular sections. The surrounding wall 41 extends from a first side of the break along the edges of the display area AA to a second side of the break to define the filling space FS and seals the filling space FS. The surrounding wall 41 includes a first end at the first side of the break and a second end at the second side of the break. A surface of the first end and a surface of the second end opposed to each other define the entrance 49. The passage walls 42 extend from the first end and the second end of the surrounding wall 41 to the upper edges of the array substrate 10 and the CF substrate 20 to define a passage IP (a liquid crystal material injection passage) through which the liquid crystal material is passed. As illustrated in FIG. 1, the outer periphery of the surrounding wall 41 is located inner than the substrate overlapping area OA, or the outer periphery of the CF substrate 20. The inner periphery of the surrounding wall 41 is located slightly outer than the edges of the display area AA. The passage TP is sealed with a sealer after the filling space FS is filled with the liquid crystal material.

A configuration for blocking foreign substances during the injection of the liquid crystal material will be described with reference to mainly FIGS. 2 and 3. As illustrated in FIGS. 2 and 3, this embodiment includes two types of ribs, that is, the first ribs 51 and second ribs 52 on the outer edge portion of the CF substrate 20 in the non-display area NAA.

As illustrated in FIG. 3, the first ribs 51 and the second ribs 52 include columnar protrusions connected to each other in a direction perpendicular to a direction in which the liquid crystal material is injected. Each of the first ribs 51 and the second ribs 52 has an elongated shape and a beaded structure. The first ribs 51 and the second ribs 52 are made of material the same as the material of the photo spacers 25. The first ribs 51 and the second ribs 52 are disposed in the same layer. The first ribs 51 and the second ribs 52 have a height the same as the height of the photo spacers 25. When the first ribs 51 and the second ribs 52 are viewed in the direction perpendicular to the normal direction of the array substrate 10 and the CF substrate 20 as illustrated in FIG. 2, the first ribs 51 and the second ribs 52 are separated from the surface of the array substrate 10 with predefined gaps. When the first ribs 51 and the second ribs 52 are viewed in the normal direction of the array substrate 10 and the CF substrate 20 as illustrated in FIG. 3, two first ribs 51 and two second ribs 52 are disposed parallel to one another between the passage walls 42.

In the passage IP defined by the passage walls 42 of the sealant 40, the first ribs 51 are disposed closer to the filling space FS ton a liquid crystal layer 30 side, a display area AA side). The first ribs 51 protrude from the base layer 23BL, which is the section of the BM layer 23 in the non-display area NAA. The second ribs 52 are disposed outer than the first ribs 51 (closer to outer edges of the liquid crystal cell 1). The second ribs 52 protrude from a section of the non-display area NAA in which the BM layer 23 is not formed.

As illustrated in FIG. 2, bases of the first ribs 51 are closer to the array substrate 10 by a thickness of the BM layer 23 in comparison to bases of the second ribs 52. The height of the first ribs 51 are about equal to the height of the second ribs 52; however, the tops of the first ribs 51 are located closer to the array substrate 10 in comparison to the tops of the second ribs 52. A distance D2 between the top of each first rib 51 and the opposed surface of the array substrate 10 is less than a distance D3 between the top of each second rib 52 and the opposed surface of the array substrate 10 (D2<D3). The cell gap D1 defined by the photo spacers 25 is greater than the distance D3 between the top of each second rib 52 and the opposed surface of the array substrate 10 (D1>D3). The following inequality is defined: D1>D3>D2.

Next, a method of producing the liquid crystal cell 1 having the configuration to block foreign substances during the injection of liquid crystal material will be described.

The glass substrate 21 for the CF substrate 20 is prepared. The color filter including the color layer 22 and the BM layer 23 is formed on the glass substrate 21 such that the BM layer 23 crosses the boundary between the display area AA and the non-display area NAA. The color filter can be formed using a known method. Through this step, the base layer 23BL is formed at a position closer to the filling space FS (closer to the liquid crystal layer 30) in the area in which the passage IP is to be formed simultaneously with the formation of the BM layer 23 that is a functional layer having the light blocking function (a functional layer and base layer simultaneous formation step).

The overcoat layer is formed on the surfaces of the color layer 22 and the BM layer 23. The photo spacers 25 for maintaining the cell gap D1 are formed to protrude from the surface of the overcoat layer. The photo spacers 25 are formed using a known method such as a photolithography method. A photo sensitive resin is applied to the surface of the overcoat layer using a known method such as roller coating and spin coating. The surface of the overcoat layer is covered with a photo mask that includes a pattern so that only sections to form the photo spacers 25 are exposed to light. Then, the photo mask is exposed to light of a predefined wavelength for a predefined period to harden the exposed sections of the overcoat. An unexposed section is removed through developing and the photo spacers 25 in the predefined shape (the columnar shape) are formed. The photo spacers 25 are formed in an area of the overcoat overlapping the BM layer 23 in the display area AA. During the formation of the photo spacers 25, the first ribs 51 and the second ribs 52 are formed at the same time. Namely, not only in the display area AA but also in the section of the non-display area NAA in which the passage IP is to be formed, a photo-sensitive resin film is formed and covered with a photo mask with a predefined pattern so that sections of the film to form the first ribs 51 and the second ribs 52 are exposed. The sections are hardened to form the ribs 51 and 52 in predefined shapes. This step for forming the photo spacers 25, the first ribs 51, and the second ribs 52 may be referred to as a spacer and rib simultaneous formation step. The photo spacers 25, the first ribs 51, and the second ribs 52 are made of the same material and formed substantially in the same height. Namely, the first ribs 51 and the second ribs 52 are formed in the same conditions in which only the photo spacers 25 are formed. The conditions include at least the material, the step, and processing conditions.

On the opposed surface of the array substrate 10 including the glass substrate 11 and functional layers formed on the glass substrate 11 and the opposed surface of the CF substrate 20 including the photo spacers 25, alignment films are formed. The sealant 40 is applied to the sealant placement area SR of the CF substrate 20 to form the surrounding wall 41 and the passage walls 42 (a sealant application step). The sealant 40 may be applied to the opposed surface of the array substrate 10 that does not include the first ribs 51 and the second ribs 52. However, the passage walls 42 can be more easily positioned relative to the first ribs 51 and the second ribs 52 if the sealant 40 is placed on the CF substrate 20 that includes the first ribs 51 and the second ribs 52. If the first ribs 51 and the second ribs 52 are formed on the array substrate 10, the sealant 40 may be applied to the opposed surface of the array substrate 10.

The CF substrate 20 on which the sealant 40 is disposed and the array substrate 10 are held with the cell gap D1 therebetween to define the filling space FS into which the liquid crystal material is to be injected. The CF substrate 20 and the array substrate 10 are bonded together with the sealant 40 (a substrate bonding step). The cell gap D1 is maintained with tops of the photo spacers 25 in the display area AA of the CF substrate 20 in contact with the opposed surface of the array substrate 10.

The liquid crystal material is injected into the filling space FS defined by the surrounding wall 41 between the array substrate 10 and the CF substrate 20 via the passage IP and the entrance 49 to the filling space FS defined by the passage walls 42 (a liquid crystal injection step).

As described earlier, the liquid crystal cell 1 includes the CF substrate 20 (a first substrate), the array substrate 10 (a second substrate), the liquid crystal layer 30, and the sealant 40. The CF substrate 20 includes the plate surface including the display area AA in which images are displayed and the non-display area NAA that surrounds the display area AA. The array substrate 10 is opposed to the CF substrate 20. The liquid crystal layer 30 is disposed between the CF substrate 20 and the array substrate 10 to overlap the display area AA. The sealant 40 bonds the CF substrate 20 and the array substrate 10 together with the cell gap D1 corresponding to the thickness of the liquid crystal layer 30 is maintained to define the filling space FS that is filled with the liquid crystal material. The sealant 40 forms the surrounding wall 41 and the passage walls 42. The surrounding wall 41 surrounds the liquid crystal layer 30 except for a section of the liquid crystal layer 30 at the entrance 49 through which the liquid crystal material is injected. The passage walls 42 connect ends of the surrounding wall 41 at the entrance 49 to the upper edge (or sections of the peripheral edge) of the CF substrate 20 to define the passage IP through which the liquid crystal material flows, in the passage IP, the base layer 23BL that is a section of the BM layer 23 is formed on the plate surface of the CF substrate 20 (a first substrate). The BM layer is made of organic material and has a thickness of 1 μm or greater. The first ribs 51 protrude from the base layer 23BL toward the array substrate 10 (a second substrate).

According to the configuration in which the ribs 51 and 52 are formed in the passage IP to block the foreign substances from entering the filling space FS, the first ribs 51 are raised by the base layer 23BL that is the section of the BM layer 23 having a relatively large thickness in comparison to other layers on the array substrate 10 and the CF substrate 20. Although the first ribs 51 do not have a large height, the first ribs 51 properly block the foreign substances. Namely, the foreign substances are properly blocked regardless of the thicknesses of the layers on the array substrate 10 and the CF substrate 20. The liquid crystal cell 1 can be prepared while the entrance of the foreign substances into the liquid crystal layer 30 is effectively reduced and thus the liquid crystal cell 1 having high display quality and reliability is obtained without an increase in the number of steps in the production process or large alteration to the processing conditions in comparison to the known production process or processing conditions.

In the liquid crystal cell 2, the photo spacers 25 are formed in the display area AA of the CF substrate 20 to maintain the cell gap D1. The first ribs 51 are made of the same material as that of the photo spacers 25 and disposed in the layer in which the photo spacers 25 are disposed. The height of the first ribs 51 is about equal to the height of the photo spacers 25. According to the configuration, the first ribs 51 are formed simultaneously with the photo spacers 25 in the step to form the photo spacers 25 without increasing the exposure time. Furthermore, because the first ribs 51 are made of the same material as that of the photo spacers 25, an additional cost is not required.

If ribs for blocking foreign substances are formed simultaneously with formation of functional layers on the glass substrate 11, layers of the ribs may be easily separated from each other or broken resulting in a reduction in resistance against a pressure of injection of the liquid crystal material. According to the configuration in which the first ribs 51 protrude from the base layer 23BL but not from the glass substrate 11, a distance between the top of each first rib 51 and the surface of the array substrate 10 can be reduced without an increase in height of each first rib 51. A resistance of the first ribs 51 against the pressure of injection can be maintained at a relatively high level. To form ribs for blocking foreign substances simultaneously with the formation of layers, a complex pattern is required for the formation of layers and thus higher accuracy may be required for positioning. Because the BM layer 23 including the base layer 23BL is form in the solid pattern, such a problem is less likely to occur.

In the liquid crystal cell 1, the BM layer 23 (the functional layer) having the light blocking properties is formed in the display area AA of the CF substrate 20. The base layer 23BL from which the first ribs 51 protrude is made of the same material as the BM layer 23 and formed in the same layer as other sections of the BM layer 23. The base layer 23BL is formed simultaneously with other sections of the BM layer 23 in the same step. Without adding a new step to the production process or altering the processing conditions, the base layer 23BL is formed. Especially, the base layer 23BL is the section of the BM layer 23 crossing the boundary between the display area AA and the non-display area NAA. Therefore the base layer 23BL and other sections of the BM layer 23 are easily formed at the same time. The base layer 23BL may be constructed of the color layer 22.

The BM layer 23 including the base layer 23BL is disposed in a section of the opposed surface of the CF substrate 20 overlapping the passage IP and closer to the filling space FS (closer to the liquid crystal layer 30). With the BM layer 23 disposed closer to the boundary of the display area AA, leak of light from the periphery of the screen is less likely to occur and thus the contrast improves. The BM layer 23 is disposed in the section of the sealant placement area SR closer to the display area AA but not in a section of the sealant placement area SR closer to the periphery of the sealant placement area SR. Therefore, the sealant 40 properly adheres to the array substrate 10 and the CF substrate 20. Furthermore, the first ribs 51 are disposed in the area of the passage IP closer to the display area AA. According to the configuration, the first ribs 51 having a higher level of performance for blocking the foreign substances and the BM layer 23 having the performance described above are provided.

The first ribs 51 are elongated protrusions that extend in the width direction of the passage IP. Each first rib 51 has a connected beads-like cross section along the XY plane. Each first rib 51 includes wavy surfaces that up and down in the width direction of the passage IP. According to the configuration, the entrance of the foreign substances that may be included in the liquid crystal material passing through the passage IP can be effectively blocked. The first ribs 51 extend in the width direction of the passage IP, that is, in a direction perpendicular to the direction in which the liquid crystal material is injected. Furthermore, the first ribs 51 include the wavy surfaces. Therefore, the foreign substances are more likely to be caught by the first ribs 51, that is, a higher level of foreign substance blocking effect can be achieved.

Two first ribs 51 are disposed parallel to each other. With the multiple first ribs 51 that are parallel to each other, the foreign substance blocking effect further improves. Furthermore, two second ribs 52 are disposed outer than the first ribs 51. The foreign substances in relatively large sizes are caught by the second ribs 52 closer to an entrance of the passage IP.

The liquid crystal cell 1 is produced by the method including the functional layer and base layer simultaneous formation step, the spacer and rib simultaneous formation step, the sealant placement step, the substrate bonding step, and the liquid crystal injection step. The functional layer and base layer simultaneous formation step includes constructing the BM layer 23 from the organic material with the thickness of 1 μm or greater in the display area AA of the CF substrate 20 and the base layer 23BL from the same organic material in the same layer at the same time. The spacer and rib simultaneous formation step includes forming the photo spacers for maintaining the cell gap D1 on the BM layer 23 and the first ribs 51 on the base layer 23BL to protrude toward the array substrate 10 at the same time. The sealant placement step Includes applying the sealant 40 to the sealant placement area of the CF substrate 20 including the peripheral area except for the passage IP and the areas adjacent to the side edges of the passage IP to form the surrounding wall 41 and the passage walls 42. The substrate bonding step includes bonding the array substrate 10 and the CF substrate 20 with the sealant 40 with the cell gap D1 between the array substrate 10 and the CF substrate 20. The liquid crystal injection step includes injecting the liquid crystal material into the filling space FS between the array substrate 10 and the CF substrate 20 through the passage IP and the entrance 49 to the filling space FS.

### Second Embodiment

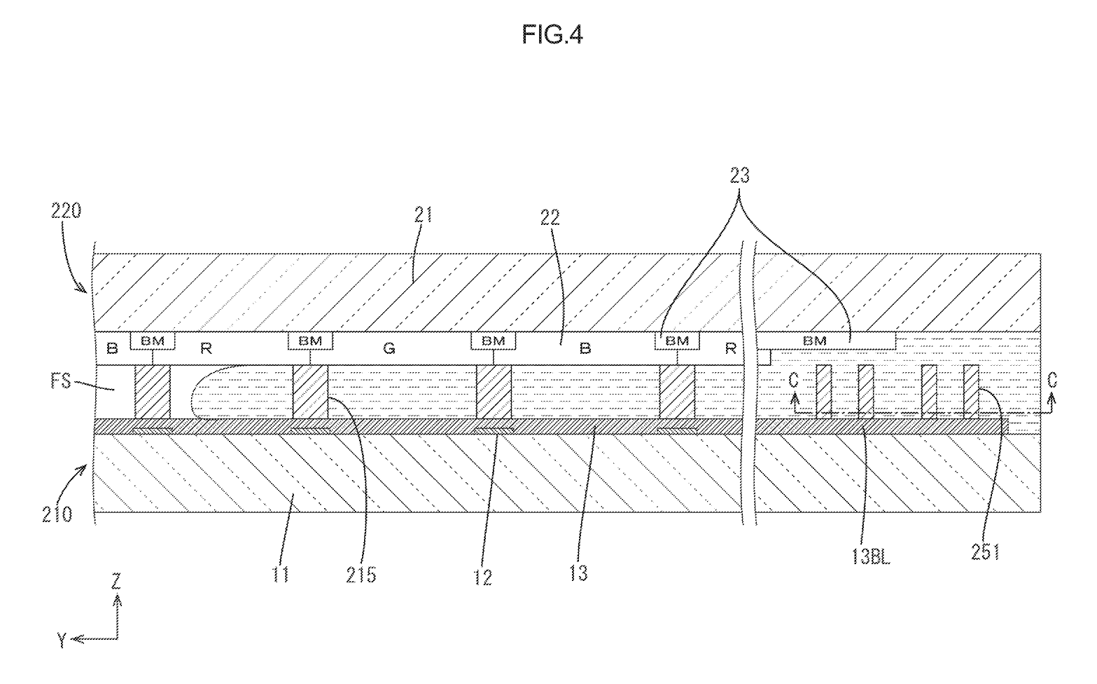

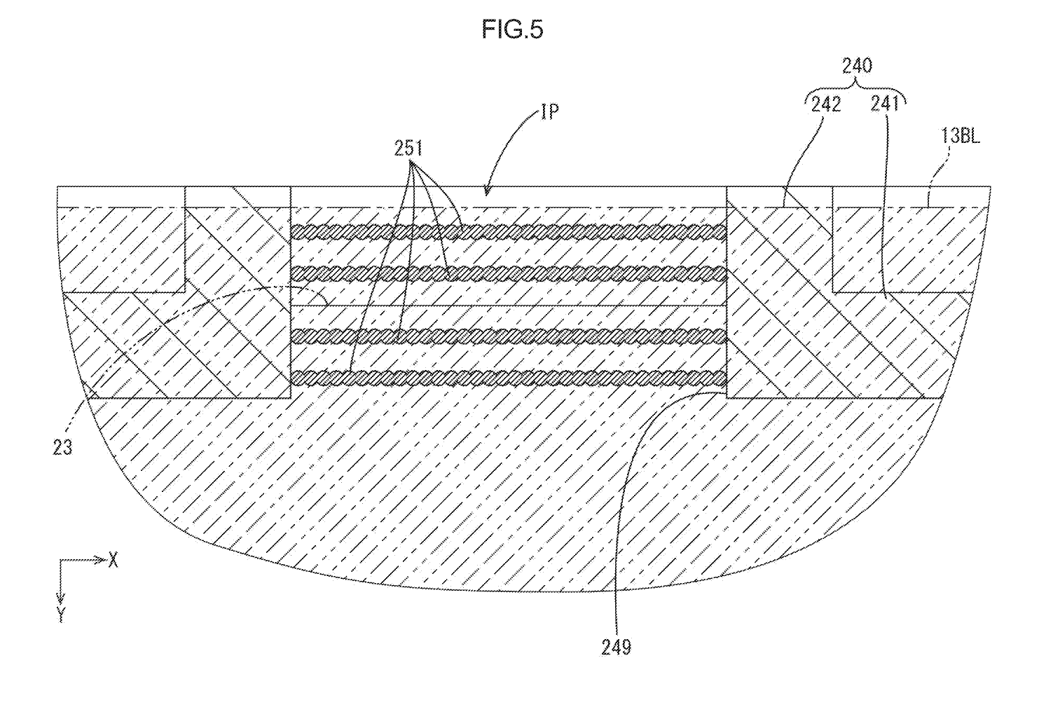

A second embodiment will be described with reference to FIGS. 4 and 5. A liquid crystal cell 201 according to the second embodiment includes first ribs 251 that protrude from the planarization layer 13 on an array substrate 210. Namely, a section of the planarization layer 13 is defined as a base layer 23BL. Other configurations of the liquid crystal cell 201 are similar to those of the liquid crystal cell 1. The configurations, functions, and effects similar to those of the first embodiment will not be described.

In the second embodiment, photo spacers 215 protrude from the array substrate 210 (a first substrate) to a CF substrate 220 (a second substrate) for maintaining a cell gap D1 between the array substrate 210 and the CF substrate 220. Four ribs 251 are disposed in the passage IP. The ribs 251 protrude from a section of the planarization layer 13 that extends closer to a periphery of a substrate overlapping area OA of the non-display area NAA of the array substrate 210. The section of the planarization layer 13 is defined as a base layer 23BL. The second embodiment does not include ribs that corresponding to the second ribs 52 in the first embodiment. All ribs 251 protrude from the planarization layer 13, that is, the ribs 251 are similar to the first ribs 51. The ribs 251 may be configured to protrude from another layer formed on the planarization layer 13.

The liquid crystal cell 201 is produced by a method including a functional layer and base layer simultaneous formation step, a spacer and rib simultaneous formation step, a sealant placement step, a substrate bonding step, and a liquid crystal injection step. The functional layer and base layer simultaneous formation step includes constructing the planarization layer 13 (a functional layer) from organic material with a thickness of 1 μm or greater in the display area AA of the array substrate 210 and the base layer BL from the same material as that of the planarization layer in the layer in which the planarization layer 13 is disposed in an area to form the passage IP at the same time. The spacer and rib simultaneous formation step includes forming the photo spacers 215 on the planarization layer 13 for maintaining the cell gap D1 and the ribs 251 on the base layer 23BL to protrude toward the CF substrate 220 at the same time. The sealant placement step includes applying a sealant 2410 to a sealant placement area SR including a periphery of the array substrate 210 except for the area to form the passage IP and areas of the array substrate 210 adjacent to side edges of the passage IP that extends from the periphery to an outer edge of the CF substrate 220 to form a surrounding wall 241 and passage walls 242. The substrate bonding step includes bonding the array substrate 210 and the CF substrate 220 with the sealant 240 with the cell gap D1 between the array substrate 210 and the CF substrate 220. The liquid crystal injection step includes injecting the liquid crystal material into a filling space FS between the array substrate 210 and the CF substrate 220 through the passage IP and the entrance 249 to the filling space FS.

With the larger number of the ribs 251 having a higher level of foreign substance blocking performance, higher foreign substance blocking effects can be achieved.

### Other Embodiments

The technology disclosed herein is not limited to the embodiments described above and with reference to the drawings. The following embodiments may be included in the technical scope.

(1) Ribs having different shapes from those in the above embodiment for blocking foreign substance may be included in the technical scope. The ribs may include bends or curves. Surfaces of the ribs may include bumps and recesses in various shapes. The ribs may have comb-like shapes. Furthermore, columnar protrusions disposed at predefined intervals may be included in the technical scope. The arrangement and the number of the ribs may be defined without limitations and may be defined according to areas of the substrates or the base layers BL. A liquid crystal cell including only one rib may be included in the technical scope. The heights of the ribs may be defined according to sizes of target foreign substances to be blocked.

(2) The technology described herein may be applied to display panels having square, round, and oval two-dimensional shapes.

(3) The technology described herein may be applied to liquid crystal cells including switching components other than TFTs (e.g., thin film diodes (TFDs)) or black-and-white liquid crystal cells.

(4) Liquid crystal cells that include common electrodes on CF substrates and operate in vertical alignment mode other than the in-plane switching mode, for instance, in VA mode and TN mode may be includes in the technical scope.

Experiment

An experiment using samples according to the technology herein will be described. The technology described herein will not be limited to samples in the experiment.

One of the samples is the liquid crystal cell 1 according to the first embodiment. The liquid crystal cell 1 was prepared by forming two first ribs 51 and to second ribs 52 at the same time as the photo spacers 25 on the CF substrate 20. The first ribs 51 protrude from sections of the BM layer 23 in the passage IP closer to the filling space FS. The second ribs 52 protrude from sections of the CF substrate 20 closer to the outer edge in which the BM layer 23 is not formed. The cell gap D1, the distance D2 between the top of each first rib 51 and the opposed surface of the array substrate 10, and the distance D3 between the top of each second rib 52 and the opposed surface of the array substrate 10 are present in TABLE 1. The first ribs 51 and the second ribs 52 are elongated protrusions having connected beads-like cross sections.

Another one of the samples is a comparative example have the same configuration as the liquid crystal cell 1 except for the first ribs 51 and the second ribs 52. The comparative example includes four ribs each having a shape and a height similar to those of the second ribs 52 in the liquid crystal cell 1. The ribs protrudes from sections in the passage IP in which the BM layer 23 is not formed.

A liquid crystal material including metal powder as foreign substances was injected into the filling space of each of the liquid crystal cell 1 and the comparative example. The entrances to the filling spaces FS filled with the liquid crystal material were sealed and the liquid crystal layers were formed. A voltage was applied to each of the liquid crystal cell 1 and the comparative example and bright spots created by short circuits between the common electrode on the CF substrate and the pixel electrodes on the array substrate 10 were counted for each of the liquid crystal cell 1 and the comparative example. Results of the experiment are present in TABLE 1.

TABLE 1

| | | LIQUID | |
|---|---|---|---|
| | | CRYSTAL | COMPARATIVE |
| | | CELL 1 | EXAMPLE |
| CELL GAP (μm) | D1 | 3.20 | 3.20 |
| DISTANCE BETWEEN | D3 | 2.10 | 2.10 |
| SECOND RIB AND | | | |
| ARRAY BOARD (μm) | | | |
| DISTANCE BETWEEN | D2 | 0.85 | — |
| FIRST RIB AND | | | |
| ARRAY BOARD (μm) | | | |

| | | |
|---|---|---|
| # OF EXAMINED CELLS | 25 | 11 |
| # OF BRIGHT SPOTS | 3 | 5 |
| MEAN OF BRIGHT SPOTS | 0.12 | 0.45 |
| PER CELL | | |

According to comparison between the liquid crystal cell 1 and the comparative example, a mean of the bright spots per cell in the liquid crystal cell 1 is about 74% less than that of the comparative example. In the comparative example, the foreign substance that passed through gaps between the ribs and the array substrate 10 having the distance D3, which was relatively large, might reach the display area AA resulting in the larger number of the bright spots. In the liquid crystal cell 1, some of the foreign substances that passed through gaps between the second ribs 52 and the opposed surface of the array substrate 10 having the distance D3 might be caught by the first ribs 51 including the tops that were the distance D2 apart from the opposed surface of the array substrate 10 resulting in the reduction in the number of the foreign substances that reached the display area AA.

The liquid crystal cell 1 was examined under a microscope from the array substrate 10 side. The foreign substance in the recesses in the surfaces of the first ribs 51 and the second ribs 52 were observed. From the examination, ribs including bumps and recesses on and in surfaces may be preferable for blocking foreign substances in comparison to ribs including flat surfaces.

1. A liquid crystal cell comprising:
a first substrate including a plate surface including a display area in which an image is displayed and a non-display area surrounding the display area;
a second substrate opposed to the first substrate;
a sealant bonding the first substrate and the second substrate together with a cell gap between the first substrate and the second substrate, the sealant being disposed along an outline of the filling space to includes:
a surrounding wall to define the filling space to define a filling space overlapping the display area and an entrance to the filling space; and
passage walls to define a passage from an outer edge of the first substrate to the entrance to the filling space to pass a liquid crystal material therethrough;
a liquid crystal layer including the liquid crystal material, disposed in the filling space, and having a thickness corresponding to the cell gap;
a base layer made of organic material and having a thickness of 1 μm or greater on a section of a plate surface of at least one of the first substrate and the second substrate in the passage; and
a protrusion protruding from the base layer toward another one of the first substrate and the second substrate.

2. The liquid crystal cell according to claim 1, wherein
one of the first substrate and the second substrate includes a functional layer in the display area, and
the base layer is made of material same as that of the functional layer and disposed in a layer in which the functional layer is disposed.

3. The liquid crystal cell according to claim 2, wherein the functional layer includes a black matrix layer disposed in a section of one of the first substrate and the second substrate overlapping the surrounding wall and the passage and closer to the liquid crystal layer in a plan view.

4. The liquid crystal cell according to claim 1, wherein
the protrusion has an elongated shape extending in a width direction of the passage, and
the protrusion includes a surface including bumps and recesses arranged in the width direction of the passage.

5. A method of producing a liquid crystal cell comprising a first substrate including a plate surface including a display area and a non-display area surrounding the display area and a second substrate opposed to the first substrate, the method comprising:
forming a functional layer on any one of the first substrate and the second substrate from an organic material and with a thickness of 1 μm or greater,
defining a section of the functional layer in an area of the any one of the first substrate and the second substrate to form a passage for a liquid crystal material as a base layer,
forming a spacer to protrude from the functional layer with a height corresponding to a cell gap between the first substrate and the second substrate,
forming a protrusion simultaneously with the forming of the spacer to protrude from the base layer toward another one of the first substrate and the second substrate,
applying a sealant to a peripheral section of the plate surface of the first substrate except for an area corresponding to the passage and sections of the plate surface of the first substrate adjacent to sides of the area corresponding to the passage,
defining a section of the sealant applied to the peripheral section as a surrounding wall,
defining sections of the sealant applied to the sides of the area corresponding to the passage as passage walls,
bonding the first substrate to the second substrate with the sealant with the cell gap between the first substrate and the second substrate,
defining a space defined by the surrounding wall between the first substrate and the second substrate as a filling space, and
injecting the liquid crystal material into the filling space via the passage defined by the passage walls.
